(19) United States
(12) Patent Application Publication
(10) Pub. No.: US 2026/0177148 A1
(43) Pub. Date: Jun. 25, 2026

(54) Dual Hardness Labyrinth Seal

(71) Applicant: GMN Bearing USA, Katy, TX (US)

(72) Inventor: Andrew Robbins, Katy, TX (US)

(21) Appl. No.: 18/991,316

(22) Filed: Dec. 20, 2024

(51) Int. Cl. F16J 15/447

(52) U.S. Cl. CPC F16J 15/4472

(57) ABSTRACT

A labyrinth seal may include an outer labyrinth seal portion, an inner labyrinth seal portion and an exterior portion. The outer labyrinth seal portion and the inner labyrinth seal portion may have a first hardness value. The inner labyrinth seal portion may be substantially coaxial with the outer labyrinth seal portion. The outer labyrinth seal portion may be interlocked to the inner labyrinth seal portion in three geometric axes. The exterior portion may have a second hardness value and may have a connection with an outer surface of the outer labyrinth seal portion. An interior portion may be connected to an outer surface of the inner labyrinth seal portion and may have the second hardness value. The second hardness value may be a lower durometer value than a durometer value of the first hardness value.

### CROSS REFERENCE TOR ELATED APPLICATIONS

Not applicable.

### STATEMENT REGARDING FEDERALLY SPONSORED RESEARCH OR DEVELOPMENT

Not applicable.

### TECHNICAL FIELD OF THE DISCLOSURE

The present disclosure relates, in general, to a labyrinth seal.

### BACKGROUND

A labyrinth seal provides a contaminant seal between two compartments. A labyrinth seal is substantially disc shaped and it operates to prevent contaminant on one side of the seal from contacting sensitive components on the opposing side of the labyrinth seal. In labyrinth seals (sometimes referred to in the art as “gap seals”), contactless sealing is effected by the provision of a sealing gap, which in general is a meandering configuration.

### SUMMARY

A first implementation disclosed herein is a labyrinth seal that may include an outer labyrinth seal portion, an inner labyrinth seal portion and an exterior portion. The outer labyrinth seal portion and the inner labyrinth seal portion may have a first hardness value. The inner labyrinth seal portion may be substantially coaxial with the outer labyrinth seal portion. The outer labyrinth seal portion may be interlocked to the inner labyrinth seal portion in three geometric axes. The exterior portion may have a second hardness value and may have a connection with an outer surface of the outer labyrinth seal portion. An interior portion may be connected to an outer surface of the inner labyrinth seal portion and may have the second hardness value. The second hardness value may be a lower durometer value than a durometer value of the first hardness value.

An anchor may be included at the connection between the exterior portion and the outer surface of the outer labyrinth seal portion. The anchor may be extend from and be integral with the outer labyrinth seal portion and have the first hardness value. The inner labyrinth seal portion may be a ring having the inner surface that is interlockingly connected to the interior portion. The anchor may include a substantially T-shaped cross-section and a horizontal member of the substantially T-shaped cross-section may be separated from the outer labyrinth seal portion by a vertical member of the T-shaped cross section.

A further implementation may be a high precision machine that includes a spindle and a labyrinth seal that may include an outer labyrinth seal portion, an inner labyrinth seal portion and an exterior portion. The outer labyrinth seal portion and the inner labyrinth seal portion may have a first hardness value. The inner labyrinth seal portion may be substantially coaxial with the outer labyrinth seal portion. The outer labyrinth seal portion may be interlocked to the inner labyrinth seal portion in three geometric axes. The exterior portion may have a second hardness value and may have a connection with an outer surface of the outer labyrinth seal portion. An interior portion may be connected to an outer surface of the inner labyrinth seal portion and may have the second hardness value. The second hardness value may be a lower durometer value than a durometer value of the first hardness value.

A yet further implementation may be a low precision machine that includes a labyrinth seal that may include an outer labyrinth seal portion, an inner labyrinth seal portion and an exterior portion. The outer labyrinth seal portion and the inner labyrinth seal portion may have a first hardness value. The inner labyrinth seal portion may be substantially coaxial with the outer labyrinth seal portion. The outer labyrinth seal portion may be interlocked to the inner labyrinth seal portion in three geometric axes. The exterior portion may have a second hardness value and may have a connection with an outer surface of the outer labyrinth seal portion. An interior portion may be connected to an outer surface of the inner labyrinth seal portion and may have the second hardness value. The second hardness value may be a lower durometer value than a durometer value of the first hardness value. The machine may be any of a hydraulic pump, a motor and a generator, etc.

### BRIEF DESCRIPTION OF THE DRAWINGS

Implementations of various techniques will hereafter be described with reference to the accompanying drawings. It should be understood, however, that the accompanying drawings illustrate only the various implementations described herein and are not meant to limit the scope of various techniques described herein.

FIG. 1 illustrates a cross-sectional view of a portion of a prior art labyrinth seal;

FIG. 2 illustrates an implementation of a labyrinth seal;

FIG. 3 illustrates a cross-sectional view of the labyrinth seal of FIG. 2;

FIG. 4A illustrates a process of manufacturing a labyrinth seal; and

FIG. 4B illustrates a further process of manufacturing a labyrinth seal.

### DETAILED DESCRIPTION

Most labyrinth seals include two coaxial rings—an outer ring and an inner ring. During most operations of a labyrinth seal one ring rotates relative to the other; however, the inner and outer rings do not contact each other.

There are regions of the outer and inner rings that are closest to each other. Those regions are surfaces that define a labyrinth path. The profile of the surface of one ring at the defined labyrinth path is a mirror, i.e., a negative image, of the profile of the mated ring. The path between the one ring and the mated ring creates the “labyrinth” path through which contaminant is unable to traverse. Multiple bends, curves and turns that are present in the path prohibit fluids, particulates, and other unwanted materials from traversing the entire path.

While a spinning labyrinth seal is more efficient in preventing fluids, particulates, and other unwanted materials from traversing the labyrinth path, it is not required that a labyrinth spin to enable prevention of fluid from traversing the labyrinth seal. Similarly, regardless of the amount of pressure that is applied to the contaminant traversing the labyrinth path, the path cannot be traversed due either to a complicated path to travel, i.e., number of bends in the path, due to centrifugal force, a combination thereof, etc., such that regardless of the amount of pressure applied, no contaminant can traverse the labyrinth path.

Previous processes of manufacturing labyrinth seals included machining the components of the seal. Three components have been required to make a labyrinth seal
an inner ring, an outer ring and a closing ring.

Due to the course of the path sometimes backtracking over itself in previous labyrinth seals, the surface of at least one of the outer ring or the inner ring must be made so that it only partially defines a path boundary. The closing ring is required to complete the remainder of the path boundary.

Labyrinth seals are typically used in precise applications. Prior art labyrinth seals cannot allow even a one percent loss of efficiency. Therefore, prior art labyrinth seals had to be designed to within as little as about one micrometer of tolerance. Due to such tight tolerances, labyrinth seals are typically expensive to manufacture.

Similarly, replacing labyrinth seals has been very expensive. Their applications require precise placement in a working environment. Therefore, installation of a labyrinth seal is labor intensive and somewhat tedious.

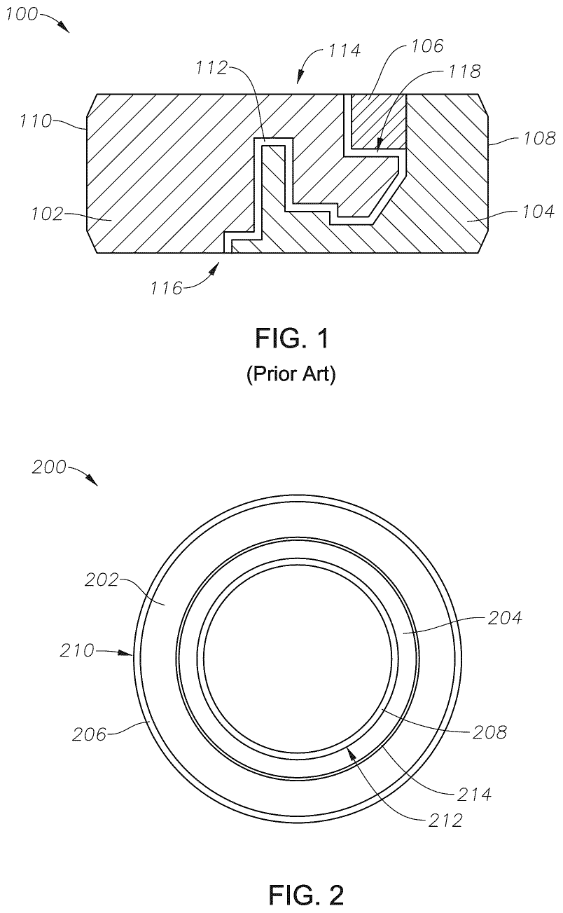

With reference to FIG. 1, a cross-sectional view of a portion of a prior art labyrinth seal 100 that would have been known to a person of skill in the art is illustrated. The labyrinth seal 100 is ring shaped and includes three components, a first component outer ring, i.e., a stator 102, a second component inner ring, i.e., a rotor 104 and a third component, i.e., a closing ring 106. An inner diameter of the labyrinth seal 100 is not illustrated in FIG. 1; however, an inner surface 108 that defines an interior hole for the labyrinth seal 100 is partly visible in FIG. 1. Inner surface 108 opposes an outer surface 110.

A labyrinth path 112 may be defined between the rotor 104 and the stator 102. The path is configured with various bends and stretches so that it prevents fluids, particulates, and other unwanted materials from passing from one side 116 of the labyrinth seal 100 to an opposing side 114 of the labyrinth seal 100. The path may even circle back over itself at, for example, region 118 where the closing ring 106 helps to define the labyrinth path 112.

The stator 102, rotor 104 and closing ring 106 are generally concentric with each other. Each of the stator 102, rotor 104 and closing ring 106 are generally monolithic. A respective inner diameter of each component 102, 104 and 106 is differently sized. The rotor 104 has the smallest inner diameter, the stator 102 has the largest inner diameter and the closing ring 106 has an inner diameter smaller than the stator 102 but larger than the rotor 104. Due to the gap, i.e., the labyrinth path 112, between the rotor 102 and stator 104 there is no friction between moving components of a labyrinth seal as the moving components are not in contact with each other.

As noted above, labyrinth seals have been used in high precision applications. Therefore, each of the three components of the prior art labyrinth seals that are used must be machined to a very precise measurement to be usable in such high precision applications. Further, the rotor 102 and stator 104 (and often the closing ring 106) were required to have the same hardness and were made of the same material. In that way, the labyrinth seal was able to accurately operate in very tight tolerance applications.

Providing a secondary material on an outer or an inner surface of the labyrinth has not been possible due to the inability to maintain the connection between the two different materials when and after sliding (press-fitting) the labyrinth seal onto a spindle, housing or other base element in applications with tight tolerances.

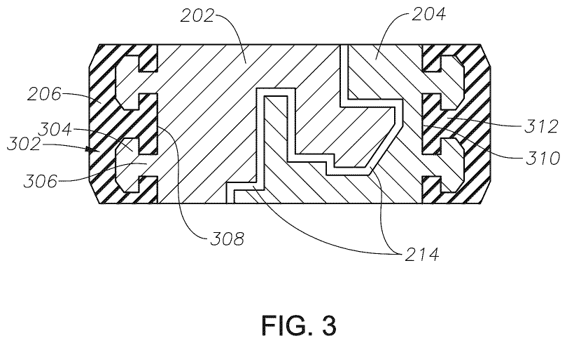

FIG. 2 illustrates an implementation of a labyrinth seal 200 of the present disclosure. The labyrinth seal 200 may include an outer ring, i.e., a stator 202 and an inner ring, i.e., a rotor 204, an exterior portion 206, an interior portion 208 and a labyrinth path 214.

A closing ring as discussed above is not a requirement in present implementations of the labyrinth seal. Instead of a closing ring helping define a portion of the labyrinth path, each surface of the labyrinth path is continuous from a first end of the labyrinth path all the way to a second end of the labyrinth path. For example, a surface of stator defines an entirety of one of two boundaries of the labyrinth path and a surface of the rotor defines an entirety of a second of two boundaries of the labyrinth path, in a negative corresponding, i.e., mirrored manner.

No replacement for a closing ring is required in present implementations, i.e., no third component is required to mate the stator to the rotor in an interlocking engagement. Notwithstanding the lack of a third component, the stator can be constructed so that it is not separable from the rotor without destroying either the stator or the rotor or both the stator and the rotor of the labyrinth seal, once the labyrinth seal is manufactured/assembled. The stator is interlockingly connected to the rotor.

The stator 202 and rotor 204 may be comprised of a hard material such as carbon steel (“steel”). The stator 202 and rotor 204 should each be made of the same material. However, this is not required. The durometer value of the materials of the stator and rotor should be the same or as similar as possible to each other. In addition to (or instead of) steel, other materials that can be used for the stator 202 and/or the rotor 204 include stainless steel, aluminum, various polymer plastics and/or elastomers, polytetrafluoroethethylene (“PTFE”), polyether ether ketone (“PEEK”), nylon or other plastics, etc.

The stator 202 may typically be attached to a portion of a machine in which it is applied that remains stationary. The rotor 204 may typically be attached to a portion of a machine that is in motion relative to the rest of the machine.

The exterior portion 206 and the interior portion 208 may be comprised of a soft material such as rubber, silicone, other elastomers or a plastic. The exterior portion 206 and the interior portion 208 can be any material that is softer than the stator 202 and the rotor 204 and may depend on the application environment of the labyrinth seal. It is not necessary that the exterior portion 206 and the interior portion 208 have the same durometer value or even that they be made of the same material as each other. . . . In addition to (or instead of) the materials noted herein, other materials that can be used for the exterior portion 206 and/or the interior portion 208 include stainless steel, aluminum, various polymer plastics and/or elastomers, polytetrafluoroethethylene (“PTFE”), polyether ether ketone (“PEEK”), nylon or other plastics, etc.

The exterior portion 206 may fit intimately on an outer surface 210 (also referred to herein as an outer diameter) of the stator 202 and the interior portion 208 may fit intimately on an outer surface 212 (also referred to as an inner diameter) of the rotor 204. By “intimate,” substantially all of the outer diameter of the stator 202 is in direct contact with the exterior portion 206 and substantially all of the inner diameter of the rotor 204 is in direct contact with the interior portion 208.

The dimensions of the stator 202 and the rotor 204, e.g., thicknesses, diameters, etc., are not limited to any particular value. For example, the outer diameter of the stator 204 can be an inch, one half inch, a quarter inch, multiple inches, etc. The inner diameter of the rotor 204 can be any size as well. It can be an inch, multiple inches, etc. Similarly, there is no limitation on relative thickness and/or the relative size of stator 202 versus the rotor 204.

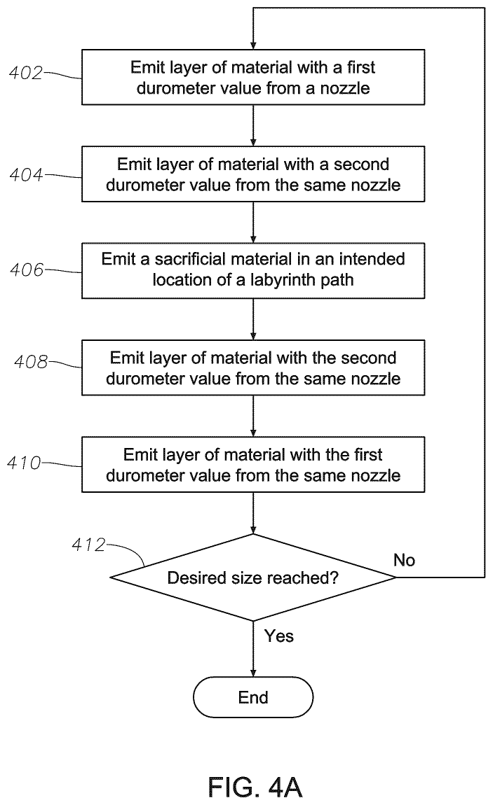

With reference to FIG. 3, to enhance the connection between exterior portion 206 and the stator 202 and/or the inner portion 208 and the rotor 204, anchors 302 and 312 can be included. The anchors 302 can project from the stator 202 into the exterior portion 206; and/or the anchors 302 can project from the rotor 204 into the interior portion 208 and vice versa.

A cross-section of anchors 302 can be upper case T-shaped, plus-shaped (+), L-shaped, mushroom shaped, bulb-shaped, etc. A T-shaped anchor, for example, may include a horizontal member 304 or a vertical member 306 or both a horizontal member 304 and a vertical member 306. It is not necessary that the anchor have different sized portions of the cross section; however, it may be considered helpful for the anchor to have a distal portion (“distal” being relative to the surface of the rotor or stator) that has a larger cross-sectional profile than a proximal portion (“proximal” also being relative to a surface of the rotor or stator).

The anchor 302 can be continuous along a surface of the stator 202 and/or rotor 204 or it can be intermittent along the surface of the stator 202 and/or rotor 204. By “continuous,” the anchor can encircle the entire labyrinth seal stator 202 and/or rotor 204. By “intermittent,” the anchor 302 may be entirely or partially around an outer surface 308 of the stator 202 and/or an inner surface 310 of the rotor 204 but include gaps and/or irregular sizing at evenly spaced or randomly spaced locations along the surface of the stator 202 and/or the rotor 204.

As noted above, anchors can instead (or also) project from the exterior portion 206 into the stator 202, from the interior portion 208 into the rotor 204 or both. For example, with further reference to FIG. 3, soft anchors 312 can project from the exterior portion 206 into the stator 202; and/or the anchors 312 can project from the interior portion 208 into the rotor 204. Soft anchors 312 may extend toward the inner surface 310 of the rotor 204. The soft anchors 312 may have cross-sections similar to that of the anchor 302. They may extend continuously along a surface of the exterior portion 206 and/or the interior portion 208 and they may extend intermittently along a surface of the exterior portion 206 and/or the interior portion 208. By “intermittent,” the soft anchor 312 may be entirely or partially around an outer surface 308 of the exterior portion 206 and/or an inner surface 310 of the interior portion 208 but include gaps and/or irregular sizing at evenly spaced or randomly spaced locations along the surface of the exterior portion 206 and/or the interior portion 208.

At least partially due to the ability to attach the exterior portion 206 and the interior portion 208 directly onto the stator and rotor, respectively, the cost of making and installing the labyrinth seal 200 is greatly reduced. For example, the need to be precise with the dimensions of the labyrinth seal 200 to within a micrometer is not necessary as the softer exterior portion 206 and interior portion 208 allows the labyrinth seal to be manufactured and/or installed with less accuracy due to the ability of the exterior portion 206 and interior portion 208 to change size.

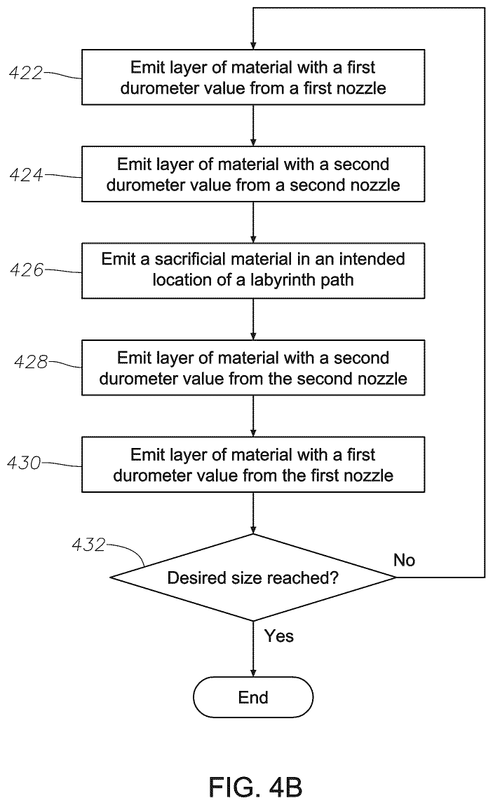

FIGS. 4A and 4B illustrate flowcharts for example processes of making a labyrinth seal. A single product having dual durometer materials may be created in a single three-dimensional (“3D”) printing process. In the present 3D printing process, it is not necessary to print a finished stator and a finished rotor and then combine these two elements to create the dual durometer labyrinth seal. It is similarly not necessary to print the stator or rotor to completion and then 3D print the other element onto the finished stator or rotor. Two materials are deposited in one layering process. Therefore, both the stator and the rotor are printed together at the same time.

A first single layer of the labyrinth seal may be 3D printed with two different materials, i.e., two materials having different durometer values, and then directly onto the first single layer, a second single layer may be printed with the two different materials having different durometer values. The second single layer would overlay the first single layer. Additional layers with two different materials having different durometer values may be 3D printed overlaying the last 3D printed layer until the desired labyrinth seal is produced.

With reference to FIG. 4A, at step 402, a layer of a material having a first durometer value is emitted from a 3D printer nozzle onto a workspace. At step 404 a layer of material having a second durometer value is emitted from the nozzle onto the workspace. For example, a layer of exterior portion 206 having a first durometer value is deposited from a nozzle onto the workspace via a 3D print process and a layer of the stator 202 having a second durometer value is 3D printed directly onto workspace in a position that it is attached directly to the exterior portion 206.

At step 406 a layer of sacrificial material may be deposited onto the workspace. For example, a sacrificial material may be laid in place where a labyrinth void, i.e., labyrinth path 214, is intended to be between the stator 202 and the rotor 204. For example, wax or other similar easily destructible material may be used to support the stator 202 and rotor 204 in place long enough so that a properly sized and positioned labyrinth path 214 can be defined between the stator 202 and the rotor 204 during the 3D printing process. After 3D printing of the stator 202 and the rotor 204 is complete, i.e., after the curing of the stator 202 and the rotor 204, the sacrificial material can be melted, chemically destroyed or otherwise removed from between the stator 202 and the rotor 204, thereby leaving a properly sized and shaped labyrinth path 214 between the stator 202 and the rotor 204.

At step 408, a layer of material having the second durometer value may be emitted from the nozzle onto the workspace directly in contact with the sacrificial material. At step 410 a layer of material having the first durometer value may be emitted from the nozzle onto the workspace, directly in contact with the layer of material having the second durometer value. For example, a layer of the rotor 204 having the second durometer value may be 3D printed onto the workspace in a position that it is attached directly to the wax material and a layer of the interior portion having the first durometer value may be deposited from the nozzle onto the workspace via a 3D print process directly in contact with the material having the second durometer value.

At step 412, a decision may be made as to whether the process is complete. For example, if a predetermined size of the labyrinth seal has been reached, i.e., enough layers have been layered by the 3D printer, the process stops. However, if additional layers are required as the labyrinth seal has not met the desired size, the process may return to step 402 and continues.

With reference to FIG. 4B, at step 422, a layer of material having a first durometer value may be emitted from a first nozzle onto a workspace. At step 424 a layer of material having a second durometer value may be emitted from a second nozzle onto the workspace. For example, a layer of exterior portion 206 having a first durometer value may be deposited from the first nozzle onto the workspace via a 3D print process and a layer of the stator 202 having a second durometer value may be 3D printed directly onto workspace by the second nozzle in a position that it is attached directly to the exterior portion 206.

At step 426, a layer of sacrificial material may be deposited onto the workspace. For example, a sacrificial material may be laid in place where a labyrinth void, i.e., labyrinth path 214, is intended to be between the stator 202 and the rotor 204. For example, wax or other similar easily destructible material may be used to support the stator 202 and the rotor 204 in place long enough so that a properly sized and shaped labyrinth path 214 can be defined between the stator 202 and the rotor 204 during the 3D printing process. After 3D printing of the stator 202 and the rotor 204 is complete, i.e., after the curing of the stator 202 and the rotor 204, the sacrificial material can be melted, chemically destroyed or otherwise removed from between the stator 202 and the rotor 204, thereby leaving a properly sized and shaped labyrinth path 214 between the stator 202 and the rotor 204.

At step 428, a layer of material having the second durometer value may be emitted from the second nozzle onto the workspace directly in contact with the sacrificial material. At step 430, a layer of material having the first durometer value may be emitted from the first nozzle onto the workspace, directly in contact with the layer of material having the second durometer value. For example, a layer of the stator 202 having the second durometer value may be 3D printed onto the workspace in a position that it is attached directly to the wax material and a layer of the rotor 204 having the first durometer value is deposited from the nozzle onto the workspace via a 3D print process directly onto the material having the second durometer value.

At step 432, a decision may be made as to whether the process is complete. For example, if a predetermined size of the labyrinth seal has been reached, i.e., enough layers have been layered by the 3D printer, the process stops. However, if additional layers are required as the labyrinth seal has not met the desired size, the process may return to step 422 and continue.

Types of applications for the labyrinth seal may vary. For example, the labyrinth seal may be press-fit on a spindle or other rotating axle in a high precision machine. High precision machines may include those having tolerances of between 5-20 microns. Most high precision machines require less than a one percent efficiency loss. Example high precision machine applications may include, but are not limited to, a spindle in a computer numerical control (“CNC”) machine or in turbo machinery, high speed motors, high efficiency motors, high speed pumps, high efficiency pumps, high speed drives, high efficiency drives, medical centrifuges, aerospace motors, centrifugal compressors, magnetic bearing applications, high efficiency and high speed rotation applications, etc.

Low precision machine applications are further appropriate environments for presently disclosed implementations of the labyrinth seal. Low precision machines have looser tolerances than high precision machines, i.e., they have a larger range of tolerance. For example, low precision machine applications may include those with tolerances of up to a millimeter or more. Types of low precision machine applications may include, but are not limited to, hydraulic pumps, electric motors, a child's toy, water pumps, coolant pumps, motors for coolant pumps, variable frequency drive (“VFD”) motors, various low precision applications that need to protect against contaminate ingress (food production equipment, food production motors/drives, manufacturing production motors/drives, manufacturing machinery motors/drive, conveyers, escalator equipment, mixers for various mediums and industries), etc. The presence of the softer outer component material enables application of implementations of the present labyrinth seal in looser tolerance applications. Seals in current low precision machines may include neoprene seals that have components that rub together and, accordingly, need to be replaced regularly.

The discussion above is directed to certain specific implementations. It is to be understood that the discussion above is only for the purpose of enabling a person with ordinary skill in the art to make and use any subject matter defined now or later by the patent “claims” found in any issued patent herein.

Applicant notes that some terms used herein have multiple definitions and/or multiple interpretations. For example, the term “interlockingly” as used herein may be interpreted as a manner in which two elements overlap, fit one within the other, are in a connected, i.e., joined configuration, and otherwise cannot be separated by simply changing the orientation or by without destroying one or both elements. The term “labyrinth” may be interpreted to mean a path that is irregular, complicated or not easily traversed or passed through. Further, “hardness” may be used interchangeably with the phrase “durometer value” and “durometer.”

It is specifically intended that the claimed invention is not limited to the implementations and illustrations contained herein but include modified forms of those implementations including portions of the implementations and combinations of elements of different implementations as come within the scope of the following claims. It should be appreciated that in the development of any such actual implementation, as in any engineering or design project, numerous implementation-specific decisions may be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.

In the above detailed description, numerous specific details were set forth in order to provide a thorough understanding of the present disclosure. However, it will be apparent to one of ordinary skill in the art that the present disclosure may be practiced without these specific details. In other instances, well-known methods, procedures, components, circuits and networks have not been described in detail so as not to unnecessarily obscure aspects of the implementation.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description of the present disclosure herein is for the purpose of describing particular implementations only and is not intended to be limiting of the present disclosure. As used in the description of the present disclosure and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context. As used herein, the terms “up” and “down”; “upper” and “lower”; “upwardly” and downwardly”; “below” and “above”; and other similar terms indicating relative positions above or below a given point or element may be used in connection with some implementations of various technologies described herein.

Use of a quantitative term or value is not limited to the exact amount recited. For example, presence of the term “about” indicates an intention to convey that the same result can be achieved by using a value that is not exactly that recited. Similarly, if an objective can be achieved by using less than all of a specified amount, it may be so indicated through use of the term “substantial” or “substantially.” For example, fifty percent of a value may be considered substantial when the same result can be achieved as if 100% of a value is used. If an exact amount is required in order to achieve a result, it will have been specifically stated.

While the foregoing is directed to implementations of various techniques described herein, other and further implementations may be devised without departing from the basic scope thereof, which may be determined by the claims that follow. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A labyrinth seal, comprising:
an outer labyrinth seal portion having a first hardness value;
an inner labyrinth seal portion having the first hardness value and disposed substantially coaxial with the outer labyrinth seal portion, wherein the inner labyrinth seal portion is not in contact with the outer labyrinth seal portion, and wherein the outer labyrinth seal portion is interlocked to the inner labyrinth seal portion in three geometric axes; and
an exterior portion having a second hardness value, the exterior portion having a connection with an outer diameter of the outer labyrinth seal portion.

2. The labyrinth seal of claim 1, wherein:
the second hardness value has a lower durometer value than the first hardness value; and
the outer labyrinth seal portion and the inner labyrinth seal portion are configured to form a labyrinth path therebetween, wherein the labyrinth path extends from a first end of the labyrinth seal to a second end of the labyrinth seal.

3. The labyrinth seal of claim 1, further comprising:
an anchor at the connection between the exterior portion and the outer diameter of the outer labyrinth seal portion, the anchor extending from and being integral with the outer labyrinth seal portion and having the first hardness value.

4. The labyrinth seal of claim 1, further comprising:
an interior portion on an inner diameter of the inner labyrinth seal portion, the interior portion having the second hardness value.

5. The labyrinth seal of claim 4, wherein the inner labyrinth seal portion is a ring including the inner diameter, and wherein the inner diameter is interlockingly connected to the interior portion.

6. The labyrinth seal of claim 4, further comprising:
an anchor at the connection between the interior portion and the inner diameter of the inner labyrinth seal portion, the anchor extending from and being integral with the inner labyrinth seal portion and having the first hardness value.

7. The labyrinth seal of claim 6, wherein the anchor comprises a substantially T-shaped cross-section, a horizontal member of the substantially T-shaped cross-section separated from the inner labyrinth seal portion by a vertical member of the T-shaped cross section.

8. The labyrinth seal of claim 1, further comprising:
an interior portion interlockingly connected to the inner labyrinth seal portion via a first anchor having a T-shaped cross-section, the interior portion having the second hardness value; and
a second anchor at the connection between the exterior portion and the outer diameter of the outer labyrinth seal portion, the second anchor being integral with and extending from the outer labyrinth seal portion and having a T-shaped cross-section and having the first hardness value;
wherein the second hardness value has a lower durometer value than the first hardness value.

9. A high precision machine, comprising:
a spindle; and
a labyrinth seal connected to the spindle, the labyrinth seal comprising:
an outer labyrinth seal portion having a first hardness value;
an inner labyrinth seal portion having the first hardness value and disposed substantially coaxial with the outer labyrinth seal portion, wherein the inner labyrinth seal portion is contactless with respect to the outer labyrinth seal portion, and wherein the outer labyrinth seal portion is interlocked to the inner labyrinth seal portion in three geometric axes; and
an exterior portion having a second hardness value, the exterior portion having a connection with an outer diameter of the outer labyrinth seal portion.

10. The high precision machine of claim 9, wherein;
the second hardness value has a lower durometer value than the first hardness value; and
the outer labyrinth seal portion and the inner labyrinth seal portion are configured to form a labyrinth path therebetween, wherein the labyrinth path extends from a first end of the labyrinth seal to a second end of the labyrinth seal.

11. The high precision machine of claim 9, further comprising:
an anchor at the connection between the exterior portion and the outer diameter of the outer labyrinth seal portion, the anchor extending from and being integral with the outer labyrinth seal portion and having the first hardness value.

12. The high precision machine of claim 9, further comprising:
an interior portion on an inner diameter of the inner labyrinth seal portion, the interior portion having the second hardness value.

13. The high precision machine of claim 12, wherein the inner labyrinth seal portion is a ring including the inner diameter, and wherein the inner diameter is interlockingly connected to the interior portion.

14. The high precision machine of claim 12, further comprising:
an anchor at the connection between the interior portion and the outer surface inner diameter of the inner labyrinth seal portion, the anchor extending from and being integral with the inner labyrinth seal portion and having the first hardness value.

15. A low precision machine, comprising:
a labyrinth seal, the labyrinth seal including:
an outer labyrinth seal portion having a first hardness value;
an inner labyrinth seal portion having the first hardness value and disposed substantially coaxial with the outer labyrinth seal portion, wherein the inner labyrinth seal portion is not in contact with the outer labyrinth seal portion, and wherein the outer labyrinth seal portion is interlocked to the inner labyrinth seal portion in three geometric axes; and
an exterior portion having a second hardness value, the exterior portion having a connection with an outer diameter of the outer labyrinth seal portion;
wherein the low precision machine is selected from the group consisting of a hydraulic pump, a motor, and a generator.

16. The low precision machine of claim 15, wherein:
the second hardness value has a lower durometer value than the first hardness value; and
the outer labyrinth seal portion and the inner labyrinth seal portion are configured to form a labyrinth path therebetween, wherein the labyrinth path extends from a first end of the labyrinth seal to a second end of the labyrinth seal.

17. The low precision machine of claim 15, further comprising:
an anchor at the connection between the exterior portion and the outer diameter of the outer labyrinth seal portion, the anchor extending from and being integral with the outer labyrinth seal portion and having the first hardness value.

18. The low precision machine of claim 15, further comprising:
an interior portion on an inner diameter of the inner labyrinth seal portion, the interior portion having the second hardness value.

19. The low precision machine of claim 18, wherein the inner labyrinth seal portion is a ring having an inner diameter, and wherein the inner diameter is interlockingly connected to the interior portion.

20. The low precision machine of claim 18, further comprising:
an anchor at the connection between the interior portion and outer surface inner diameter of the inner labyrinth seal portion, the anchor extending from and being integral with the inner labyrinth seal portion and having the first hardness value.
